(19) United States
(12) Patent Application Publication
(10) Pub. No.: US 2014/0009074 A1
(43) Pub. Date: Jan. 9, 2014

(54) LED LAMP STRING

(71) Applicant: Yin Chen, Shenzhen (CN)

(72) Inventor: Yin Chen, Shenzhen (CN)

(73) Assignee: CHEF D'OEUVRE ELECTRONICS (SHENZHEN) LTD., Shenzhen, Guangdong (CN)

(21) Appl. No.: 13/993,682

(22) PCT Filed: Dec. 13, 2010
(86) PCT No.: PCT/CN2010/079727

§ 371 Date: Aug. 16, 2013

(51) Int. Cl. F21S 4/00

(52) U.S. Cl. CPC F21S 4/001
USPC 315/185 R

(57) ABSTRACT

The present invention relates to LED lamp string, comprising at least three conducting wires with insulating layers. One of the conducting wires is a positive conducting wire, and the others are negative conducting wires. A mounting part is provided on each negative conducting wire at every certain interval. A light emitting wafer is fixed to the mounting part. The light emitting wafer comprises a first electrode and a second electrode which are separately provided. The first electrode of the light emitting wafer connected with each negative conducting wire is electrically connected with the conductor of the same negative conducting wire. The second electrode is electrically connected with the conductor of the positive conducting wire via a wire. A transparent outer sealing gum encapsulating the mounting part, the light emitting wafer and the wire is provided on the LED lamp string.

### FIELD OF THE INVENTION

The present invention relates to the field of illumination, and more specifically to an LED lamp string.

### BACKGROUND OF THE INVENTION

The lamp strings in the market generally comprise LED lamps welded on the conducting wire, thus having reduced the beauty of the structure and increased the cost. Alternatively, the LED lamp strings have two wires, on which the light emitting wafers are connected in parallel based on the enameled wire, one of the wires is positive electrode, and the other is negative electrode, the string of lamps will be lighted if two wires are communicated. Besides that, the lamp string is a kind of monochromatic lamp whose light color doesn't change and appearance isn't nice enough, and the color diversity can be achieved only by using multiple monochromatic enameled wires.

### SUMMARY OF THE INVENTION

The object of the present invention is to provide an LED lamp string, aiming at the defects that the above structure is not nice, the cost is high and the color is single in the prior art.

The technical solutions of the present invention for solving the technical problems are as follows: an LED lamp string is provided, it comprises at least three conducting wires with insulating layers, one of the conducting wires is a positive conducting wire, and the others are negative conducting wires; a mounting part is provided on each negative conducting wire at every certain intervals, a light emitting wafer is fixed to the mounting part; the light emitting wafer comprises a first electrode and a second electrode which are separately provided;

the first electrode of the light emitting wafer on each negative conducting wire is electrically connected with a conductor of the same negative conducting wire, the second electrode is electrically connected with a conductor of the positive conducting wire via a wire; a transparent outer sealing gum encapsulating the mounting part, the light emitting wafer and the wire is provided on the LED lamp string.

In the LED lamp string according to the present invention, the mounting part is a flat mounting part.

In the LED lamp string according to the present invention, the LED lamp string comprises three conducting wires with insulating layers, one of the conducting wires is a positive conducting wire, and the others are a first negative conducting wire and a second negative conducting wire;

the first electrode of the light emitting wafer on the first negative conducting wire is electrically connected with the conductor of the same negative conducting wire via a conducting gum, the first electrode of the light emitting wafer on the second negative conducting wire is electrically connected with the conductor of the same negative conducting wire via the wire, the second electrode of the light emitting wafer on the first negative conducting wire and the second negative conducting wire is electrically connected with the conductor of the positive conducting wire via the wire.

In the LED lamp string according to the present invention, the LED lamp string comprises four conducting wires with insulating layers, one of the conducting wires is a positive conducting wire, and the others are a first negative conducting wire, a second negative conducting wire and a third conducting wire;

the first electrode of the light emitting wafer on each of the first negative conducting wire and the second conducting wire is electrically connected with the conductor of the same negative conducting wire via the wire, the first electrode of the light emitting wafer on the third negative conducting wire is electrically connected with the conductor of the same negative conducting wire via a conducting gum;

the second electrode of the light emitting wafer on the first negative conducting wire is electrically connected with the conductor of the positive conducting wire via the wire, the second electrode of the light emitting wafer on the second negative conducting wire is electrically connected with the second electrode of the light emitting wafer on the first negative conducting wire via the wire, the second electrode of the light emitting wafer on the third negative conducting wire is electrically connected with the second electrode of the light emitting wafer on the second negative conducting wire via the wire.

In the LED lamp string according to the present invention, the wire is a gold wire, a silver wire, or an aluminum wire.

In the LED lamp string according to the present invention, the LED lamp string is further electrically connected with an IC controller which controls the flash mode of the light emitting wafer.

In the LED lamp string according to the present invention, the light emitting wafer is fixed to the mounting part of the conducting wire via a solid crystal gum.

By implementing the LED lamp string in the present invention, the following advantages can be achieved: the multiplicity of the colors is realized by parallel wires and an external IC controller. The light emitting wafer is directly fixed to the conducting wire encapsulated with the insulating layer, thus the cost is reduced and the production is more convenient. The LED lamp string is compact and slim, making the product more beautiful, with good flexibility and wide range of applications.

### BRIEF DESCRIPTION OF THE DRAWINGS

The present invention will be further described with reference to the accompanying drawings and embodiments, in the accompanying drawings:

FIG. 1 illustrates the structure of an LED lamp string according to a first embodiment of the present invention;

FIG. 2 illustrates the structure of an LED lamp string according to a second embodiment of the present invention;

List of References: 1 denotes the positive conducting wire, 2 denotes the first negative conducting wire, 3 denotes the second negative conducting wire, 4 denotes the third negative conducting wire, 5 denotes the mounting part, 6 denotes the light emitting wafer, 7 denotes the wire, 8 denotes the transparent outer sealing gum.

### DETAILED DESCRIPTION OF THE PREFERRED EMBODIMENT

### The First Embodiment

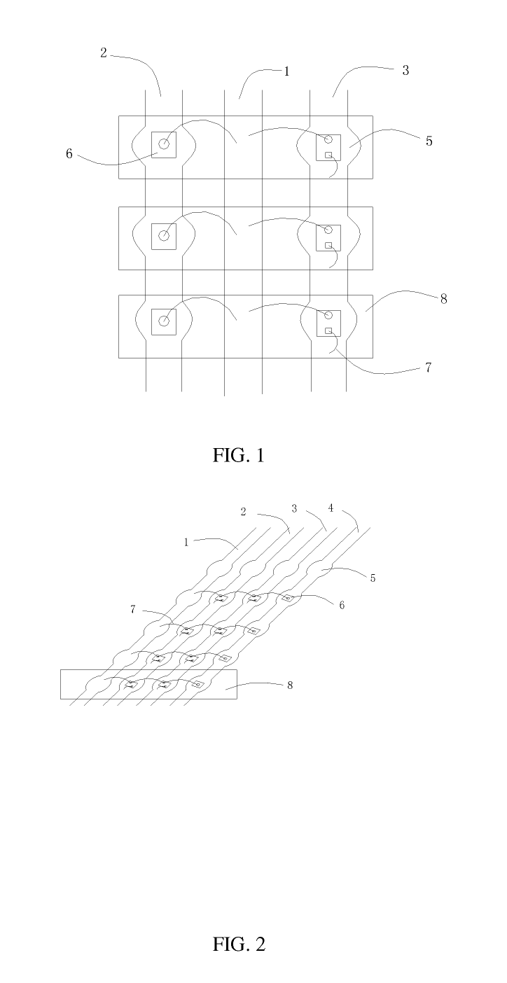

As shown in FIG. 1, in the first embodiment of the present invention, an LED lamp string comprises three conducting wires with insulating layers, including a shared positive conducting wire 1, a first negative conducting wire 2 and a second negative conducting wire 3. These three conducting wires constitute a galvanic circle. It should be noted that a shared negative conducting wire also can be adopted, and two positive conducting wires and the shared negative conducting wire constitute a galvanic circle. The conducting wire comprises a conductor and an insulating layer encapsulating the conductor. The insulating layer is usually made of insulating paint which resistant to high temperature. Wherein, a mounting part 5 is provided on the first negative conducting wire 2 and the second negative conducting wire 3 at every certain interval, and all mounting parts 5 are set on the same position of each negative conducting wire to facilitate the color configuration. The mounting part 5 may be a flat mounting part to facilitate mounting. Namely, this part of the conducting wire is punched to be flat and the conductor of the conducting wire is revealed, and then a light emitting wafer 6 is fixed to the mounting part 5 via a solid crystal gum.

The light emitting wafer 6 comprises two electrodes including a first electrode and a second electrode. Usually, the first electrode of each of the red light emitting wafer and the yellow light emitting wafer is located at the bottom of the wafer, so that this kind of wafer can be fixed to the mounting part 5 via the conducting gum to enable the first electrode electrically connected with the conductor of the same conducting wire. However, the first electrode of each of the green light emitting wafer and the blue light emitting wafer is electrically connected with the conductor of the same conducting wire via a wire 7.

It should be noted that, only the light emitting wafers with the same power can be fixed to the same negative conducting wire. For example, the red light emitting wafer and the yellow light emitting wafer have the same power, and the green and blue light emitting wafer have the same power. In the present embodiment, the light emitting wafers 6 on the first negative conducting wire 2 are alternate red and yellow wafers, and the light emitting wafers 6 on the second negative conducting wire 3 are alternate green and blue wafers. Thus the LED lamp string is more colorful. It is also possible that all the light emitting wafers fixed on the first negative conducting wire 2 are red or yellow, and all the light emitting wafers fixed on the second negative conducting wire 3 are green or blue.

In order to connect the light emitting wafers 6 on the first negative conducting wire 2 and that on the second negative conducting wire 3 in parallel, the second electrodes of all the light emitting wafers 6 are electrically connected with the conductor of the shared positive conducting wire 1 via the wire 7. The wire 7 may be a gold wire, a silver wire, or an aluminum wire.

In order to protect the above connecting structure of the LED lamp string, the adjacent light emitting wafers 6 on two negative conducting wires are encapsulated with a transparent outer sealing gum (referring to FIG. 1). The transparent outer sealing gum can not only protect the connection between the light emitting wafer 6 and the conducting wire, but also not affect the light emission, thus making the whole LED lamp string more beautiful.

At the same time, an external controlling circuit can be connected to the conducting wires of the LED lamp string to achieve flash and color effects, thus making the LED lamp string display richer shining effects.

### The Second Embodiment

Referring to FIG. 2, in the embodiment, the LED lamp string comprises four conducting wires with insulating layers, including a shared positive conducting wire 1, a first negative conducting wire 2, a second negative conducting wire 3 and a third conducting wire 4. It should be noted that a shared negative conducting wire also can be adopted, and three positive conducting wires and the shared negative conducting wire constitute a galvanic circle. A mounting part 5 is provided on each negative conducting wire at every certain interval. The mounting part 5 may be punched to be a flat mounting part. The light emitting wafer 6 is fixed to the negative conducting wire via the solid crystal gum.

The first electrode of the light emitting wafer 6 on each of the first negative conducting wire 2 and the second conducting wire 3 is electrically connected with the conductor of the same negative conducting wire via the wire 7. As the first electrode of the light emitting wafer 6 on the third negative conducting wire 4 is located at the bottom of the light emitting wafer 6, the first electrode is electrically connected with the conductor of the same negative conducting wire via a conducting gum. In order to connect the light emitting wafers 6 on each of three negative conducting wires in parallel, the second electrode of the light emitting wafer 6 on the first negative conducting wire 2 is electrically connected with the conductor of the positive conducting wire 1 via the wire 7, the second electrode of the light emitting wafer 6 on the second negative conducting wire 3 is electrically connected with the second electrode of the adjacent light emitting wafer 6 on the first negative conducting wire 2 via the wire 7, the second electrode of the light emitting wafer 6 on the third negative conducting wire 4 is electrically connected with the second electrode of the adjacent light emitting wafer 6 on the second negative conducting wire 3 via the wire 7. The wire 7 may be a gold wire, a silver wire, or an aluminum wire.

It should be noted that, in the present embodiment, the light emitting wafers 6 on the first negative conducting wire 2 are all red, the light emitting wafers 6 on the second negative conducting wire 3 are all yellow, and the light emitting wafers 6 on the third negative conducting wire 4 are all blue. Thus, the LED lamp string can emit light of seven different colors if it is connected with an external IC controller, to achieve a colorful effect.

Similarly, in order to protect the connecting structure of the LED lamp string, the adjacent light emitting wafers 6 are encapsulated with a transparent outer sealing gum 8 (as shown in FIG. 2). The transparent outer sealing gum 8 can not only protect the connection between the light emitting wafer 6 and the conducting wire, but also not affect the light emission, thus making the whole LED lamp string more beautiful.

While the present invention has been described with reference to preferred embodiments, it will be understood by one skilled in the art that various changes and equivalents may be substituted without departing from the scope of the present invention, and those various changes and equivalents shall fall into the protection of the invention.

1-7. (canceled)

8. An LED lamp string, comprising at least three conducting wires with insulating layers, one of the conducting wires is a positive conducting wire, and the others are negative conducting wires; a mounting part is provided on each negative conducting wire at every certain intervals, a light emitting wafer is fixed to the mounting part; the light emitting wafer comprises a first electrode and a second electrode which are separately provided;
the first electrode of the light emitting wafer on each negative conducting wire is electrically connected with a conductor of the same negative conducting wire, the second electrode is electrically connected with a conductor of the positive conducting wire via the wire; a transparent outer sealing gum encapsulating the mounting part, the light emitting wafer and the wire is provided on the LED lamp string.

9. The LED lamp string according to claim 8, wherein the mounting part is a flat mounting part.

10. The LED lamp string according to claim 8, wherein the LED lamp string comprises three conducting wires with insulating layers, one of the conducting wires is a positive conducting wire, and the others are a first negative conducting wire and a second negative conducting wire; the first electrode of the light emitting wafer on the first negative conducting wire is electrically connected with the conductor of the same negative conducting wire via a conducting gum, the first electrode of the light emitting wafer on the second negative conducting wire is electrically connected with the conductor of the same negative conducting wire via the wire, the second electrode of the light emitting wafer on the first negative conducting wire and the second negative conducting wire is electrically connected with the conductor of the positive conducting wire via the wire.

11. The LED lamp string according to claim 8, wherein the LED lamp string comprises four conducting wires with insulating layers, one of the conducting wires is a positive conducting wire, and the others are a first negative conducting wire, a second negative conducting wire and a third conducting wire;
the first electrode of the light emitting wafer on each of the first negative conducting wire and the second conducting wire is electrically connected with the conductor of the same negative conducting wire via the wire, the first electrode of the light emitting wafer on the third negative conducting wire is electrically connected with the conductor of the same negative conducting wire via a conducting gum;
the second electrode of the light emitting wafer on the first negative conducting wire is electrically connected with the conductor of the positive conducting wire via the wire, the second electrode of the light emitting wafer on the second negative conducting wire is electrically connected with the second electrode of the light emitting wafer on the first negative conducting wire via the wire, the second electrode of the light emitting wafer on the third negative conducting wire is electrically connected with the second electrode of the light emitting wafer on the second negative conducting wire via the wire.

12. The LED lamp string according to claim 8, wherein the wire is a gold wire, a silver wire, or an aluminum wire.

13. The LED lamp string according to claim 10, wherein the wire is a gold wire, a silver wire, or an aluminum wire.

14. The LED lamp string according to claim 11, wherein the wire is a gold wire, a silver wire, or an aluminum wire.

15. The LED lamp string according to claim 8, wherein the LED lamp string is further electrically connected with an IC controller which controls the flash mode of the light emitting wafer.

16. The LED lamp string according to claim 8, wherein, the light emitting wafer is fixed to the mounting part of the conducting wire via a solid crystal gum.
